(19) United States
(12) Patent Application Publication
(10) Pub. No.: US 2007/0110168 A1
(43) Pub. Date: May 17, 2007

(54) Method for generating high quality, low delay video streaming

(76) Inventors: Dmitry Kravtsov, Letzion (IL); Gidon Tahan, Jerusalem (IL)

Correspondence Address: HENRY M. SINAI;(IP-PARTNERSHIP), P.O. BOX 669, RAANANA, 43350, IL

(21) Appl. No.: 10/572,598

(22) PCT Filed:
(86) PCT No.: PCT/IL04/00868

(30) Foreign Application Priority Data
Sep. 21, 2003 (IL) 158025
Sep. 21, 2003 (IL) 158026

(51) Int. Cl. H04N 7/12

(52) U.S. Cl. 375/240.26

(57) ABSTRACT

A method for generating low delay video streaming is provided. In an embodiment, the bit rate desired for outputting the received video stream is input into a buffer (32 of FIG. 1), determining the size of the buffer according to the bit rate, outputting the video frame (36 of FIG. 1) according to the bit rate and the buffer size by varying the bit rate accordingly to obtain the level of quality and delay period required. Additionally, a header may be assigned to each frame and the sleep time for each frame is allocated prior to the time for frame compression.

### FIELD OF THE INVENTION

The present invention relates to the field of video streaming in general and to a method for improving the quality of a video stream.

### BACKGROUND OF THE INVENTION

Generally, in order to achieve quality video streaming, a large buffer is used to enable a quality stream with low sensitivity to without bandwidth fluctuations. Internet based players were characterized as “wait a long time to watch well for a short time”.

To overcome the disadvantage of having to wait, the market developed high compression ratio (CR) schemes. As the compression ratio increases, the amount of data decreases and thus, the wait time is also reduced. However, these solutions that reduced the user “wait time” by using a high CR required a large buffer.

In the video detection surveillance market there are two basic requirements: Firstly, there is a need for high quality recording for individuals and the ability to detect when an “event” occurs. In this case, real time video having a low delay is not a priority.

In a second scenario, real time video with ultra low delay is critical. For example, policemen, security guards and soldiers need to react quickly and thus need to receive real time video within a short wait time (say up to 2.5 seconds).

In recent years, the development of the cellular telephone infrastructure has led to the support of multimedia video streaming. It is high likely that this feature will become increasingly popular. Cellular infrastructure uses one of the narrowest bandwidths available today, commonly between 9-28 kbps. Achieving a reasonable performance in cellular infrastructure will probably lead to a higher performance expectation on other media such as PSTN, IDSN and LAN networks for example.

The bandwidth on packed-based networks is prone to fluctuation and may vary from high to low or vice-versa drastically. Bandwidth fluctuation may generate undesirable “effects” on the streaming such as “fast forward” (frames moving too fast) or “slow motion” (frames moving at too slow a rate).

As the compression becomes increasingly complex, the processor's computing power needs to increase too. In an environment, where a server is responsible for supporting many clients and thus, many and different video streams, the processor's computing power becomes critical.

There is thus a need for a method and system for achieving quality video streaming which may be received by the client without the lengthy delay of existing systems.

### SUMMARY OF THE INVENTION

The present invention is directed to a method for smoothly displaying the frames of a video stream using relatively low powered computer systems.

A method for generating low delay video streaming is provided. In an embodiment, the bit rate desired for outputting the received video stream is input into a buffer, determining the size of the buffer according to the bit rate, outputting the video frame according to the bit rate and the buffer size by varying the bit rate accordingly to obtain the level of quality and delay period required. Additionally, a header may be assigned to each frame and the sleep time for each frame is allocated prior to the time for frame compression.

There is thus provided, according to an embodiment of the invention, a method for generating low delay video streaming. The method including the steps of:

inputting the bit rate desired for outputting the received video stream into a buffer;

determining the size of the buffer according to the bit rate;
adjusting said bit rate; and
repeating the steps of determining and adjusting thereby to output the video stream at the highest bit rate consistent with optimum levels of quality for a predetermined period of delay.

Furthermore, according to an embodiment of the invention, the step of determining includes the step of verifying the “Current_Pointer” position wherein “Buffer Pointer”−“Delta_Buffer_Pointer”<“Current_Pointer”<“Buffer Pointer”+“Delta Buffer_Pointer”.

Furthermore, according to an embodiment of the invention, the step of varying includes the steps of:

determining whether the “Current_Pointer” is within the range appropriate to the current bit rate; and

if the “Current_Pointer” is within the range, recording a plurality of measurements of the time taken for a message from the server's transmitter to the clients receiver and back again to the transmitter (RTT); and

if the “Current_Pointer” is within the range, increasing the bit rate.

According to an embodiment of the invention, if the “Current_Pointer” is lower than the range for the current bit rate, the bit rate may be reduced.

There is also provided, according to an embodiment of the invention, a method for method for smoothly displaying the frames of a video stream, the method including the steps of:

assigning a header to a first frame of a series of frames of a video stream to be encoded;

allocating a period of time to the first frame before encoding, the period of time corresponding to the delay time of the first frame;

compressing the first frame; and

repeating the steps of assigning, allocating and compressing for each subsequent frame to be encoded.

Furthermore, according to an embodiment of the invention, the step of adjusting comprises the steps of:

inputting the bit rate desired for outputting the received video stream into a buffer;

determining the size of said buffer according to said bit rate;
adjusting said bit rate; and
repeating the steps of determining and adjusting thereby to output the video stream at the highest bit rate consistent with optimum levels of quality for a pre-determined period of delay.

Furthermore, according to an embodiment of the invention, the method further includes the steps of:

transmitting the encoded series of frames to a buffer located at the client site; and

adjusting the size of the buffer in response to a dynamically varying bandwidth.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a schematic block diagram illustration of a system for transmitting video sequences using video compression;

FIG. 2 is schematic block diagram illustration of the MPEG encoder of FIG. 1, constructed and operative according to an embodiment of the invention;

FIG. 3 is a detailed schematic block diagram illustration of the interfaces of the buffer at the client server, constructed and operative according to an embodiment of the invention;

FIG. 4 is a schematic illustration of the system for determining the optimum bit rate for video streaming, constructed and operative according to an embodiment of the invention;

FIG. 5 is a schematic flow chart illustration of the method for controlling the size of the buffer of FIG. 3;

FIG. 6 is a schematic block diagram illustration of the encoding of a video stream; and

FIG. 7 is a schematic illustration of a video streaming format, constructed and operative according to an embodiment of the invention.

### DETAILED DESCRIPTION OF PREFERRED EMBODIMENTS

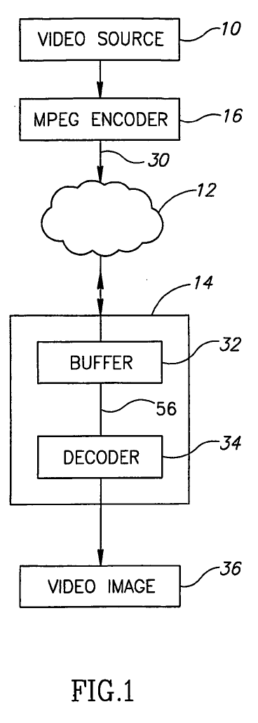

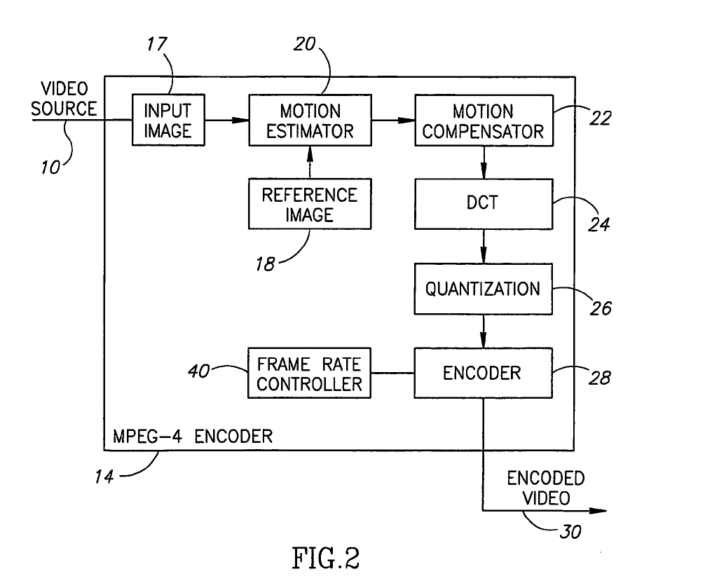

Reference is now made to FIGS. 1 and 2. FIG. 1 is a schematic bock diagram illustration of a system for transmitting video sequences using video compression, such as MPEG-4 (Moving Picture Expert Group), for example, from a source 10 via the Internet 12 to a client 14. FIG. 2 is schematic block diagram illustration of the MPEG encoder of FIG. 1, constructed and operative according to an embodiment of the invention.

The raw (uncompressed) video images from the source 12 are input to the MPEG (Moving Picture Expert Group) video compression encoder 16. As is known in the art, a standard MPEG video compression device generally includes, inter alia, frame storage units for the input images and for the reference image 17 and 18, respectively, modules for motion estimation 20 and motion compensation 22.

Motion vectors are defined in the Moving Picture Expert Group (MPEG) standard specification. Briefly, when a digital image frame 17 is input, the motion estimation unit 20 estimates a motion vector on a macroblock by macroblock basis with reference to a reference image frame 18. The estimated motion vector is transmitted to the motion compensation unit 22, where an estimate of the movement of each macro block from the location of the current macro block is obtained.

In parallel, the frame storage unit stores the input image frame 17 in a storage unit The difference in value between the macro block of the input image frame and the estimated motion vector is compressed in the discrete cosine transform (DCT) unit 24 and the quantization unit 26. The compressed data are transformed into an MPEG stream in the encoding unit 28. The compressed data are restored and added to the motion compensated prediction data and stored in a reference frame storage unit 18 as a reference image frame for the next frame input. The encoded video stream 30 is then sent via the Internet 12 to the client 14.

Generally the client 14, which receives the encoded stream, may comprise a buffer 32 for buffering the encoded data prior to being decoded by a decoder 34. Once the information representative of a video frame is decoded, the video frame may be displayed 36.

In an embodiment of the present invention, the system further comprises a frame rate controller 40 coupled to the encoder 16. The frame rate controller 40 is operable to determine the encoding bit rate and the speed at which the encoded frames should be sent.

The rate at which the encoded stream is sent to the client is determined by the frame rate controller 40 at the source. In an exemplary situation, the source determines that the “preferred” rate to send the stream is 20 kilobits/sec. Generally, the source begins transmitting at a lower rate, say 10 kilobits/sec and gradually increases the rate until the preferred rate is achieved. However, if there are communication problems due to bandwidth restrictions, for example, the rate of transmission slows down and the preferred rate is never achieved.

The delay in transmission may also be due to a blockage or overload in the Internet, which prevents the client from receiving a continuous feed.

Applicants have realized that high quality video streaming may be achieved with a relative low delay by controlling the buffering of the encoded stream received at the client's server.

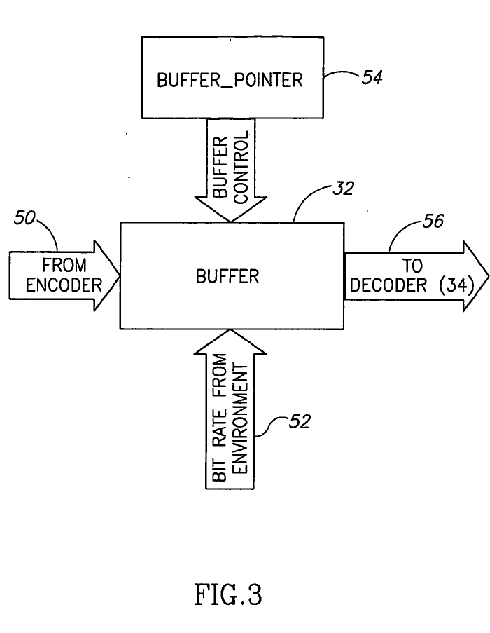

Reference is now made to FIG. 3, which is a detailed schematic block diagram illustration of the interfaces of the buffer 32 at the client server, constructed and operative according to an embodiment of the invention.

The buffer 32 is configured to have a dynamic interface into which the encoded video stream (line 50) is input. Additionally, the buffer 32 receives the user-defined bit rate 52 and input from a buffer pointer 54. The buffer pointer 44 is operative to control the decoding and the bandwidth and quality of the output video frames (line 56) which are sent to the decoder 34 for outputting (video stream 36).

The client server 14 is responsible for the buffering the data received. The buffer 32 has dynamical size, so that if the buffer is larger, delay will be longer and vice versa.

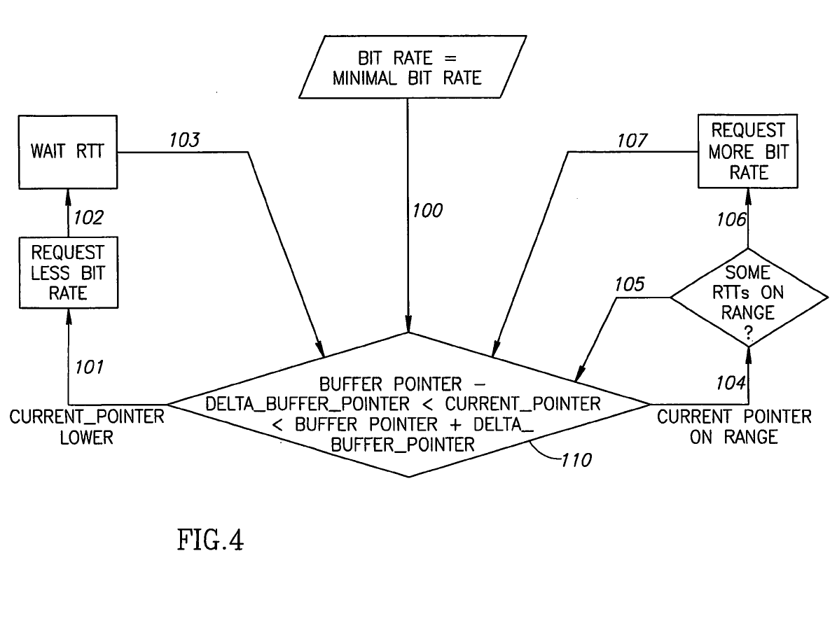

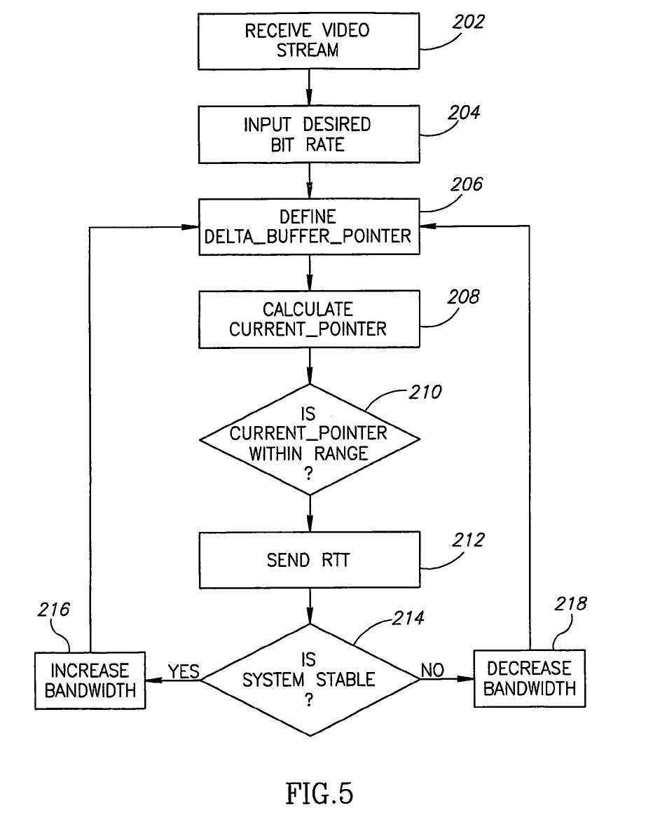

Reference is now made to FIGS. 4 and 5. FIG. 4 is a schematic illustration of the system for determining the optimum bit rate for video streaming. FIG. 5 is a schematic flow chart illustration of the method for controlling the size of the buffer 32, constructed and operative according to an embodiment of the invention.

The buffer 32 acts as a first-in first-out (FIFO) buffer where the data being stored is entered at the top of the stack and is shifted down toward the bottom of the stack as new data comes in at the top.

The size of the buffer is determined by various parameters, such as the available bandwidth (or bit rate). The size of the buffer is constantly checked, by verifying the “Current_Pointer” position (query box 110—FIG. 4).

After each frame, a message may be sent from the frame rate controller 40 of the encoder 16 to the client decoder 34 and the round trip time (RTT) taken, to receive feedback, is measured. RTT (Round trip time) is the time taken for a message from the server's transmitter to the clients receiver and back again to the transmitter. It is defined by the bandwidth available (which is the most significant factor and by the dataflow inside the server and client.

After each frame is received, it is possible to send a new message to encoder. However, since the possibility of making a change is determined by the RTT, in practice a message is sent to the encoder after each RTT.

If the “Current_Pointer” is within the range, that is the RTT is within the pre-determined acceptable range, the system may be defined as being in a “stable” condition (processes 104, 105).

However, since it is desirable to achieve the highest bit rate possible which is consistent with quality, a request for increased bandwidth is sent to encoder 16 (processes 106, 107). After each change of bandwidth, the size of the buffer is again checked to determine whether the RTT is still within the acceptable range. If so, a further increase in the bit rate may be made.

If the “Current_Pointer” is lower, a request to reduce the bit rate is sent to the frame rate controller 40 of the encoder (processes 101-103).

Referring to the flow chart of FIG. 5, the video stream is received into the client buffer (step 202), whose size (“buffer size”) is defined by the “Current_Pointer_Position”.

The user inputs the desired frame rate (step 204) and a “Delta_Buffer_Pointer” is defined based on the input frame rate (step 206). The “Current_Pointer” is re-calculated (step 208) and may be defined as:

“Buffer Pointer”−“Delta_Buffer Pointer”<“Current_Pointer”<“Buffer Pointer”+“Delta_Buffer_Pointer” (110 in FIG. 4).

The “Delta_Buffer_Size” is a constant, so the maximum change on bandwidth is proportionally (the buffer is measured in bytes and the bandwidth in kbits/s (kilobits/sec)) lower than the “Delta_Buffer_Size”.

The “Current_Buffer_Size” selected is appropriate to the instantaneous bandwidth available.

A check is then made to determine whether the “Current_Pointer” is within the range appropriate to the current bit rate (query box 210), that is that the frame rate output to the decoder matches the delay time and quality level consistent with pre-determined levels.

If affirmative, a message is sent to the encoder and the time to send and receive feedback (round trip time (RTT)) is measured (step 212). If the system is remains stable after several measurements of RTT (query box 214), a request for increased bandwidth is sent to the encoder (step 216).

However, if the “Current_Pointer” is lower, a request to reduce the bit rate is sent to the encoder (step 218).

After each change in bandwidth, steps 206-214 are repeated.

Thus, the client server is operative to control the optimized bit rate while concurrently reducing the delay to a minimum. In practice, the delay utilizing the invention of the present application is approximately 3 seconds in contrast to over 30 seconds delay commonly accepted today.

Furthermore, there is an optimized balance between delay, bandwidth and quality factors so that the client can effectively control the parameters and output the type of video stream desired.

Applicants have realized that by controlling the time to send the video frames, the client may receive high quality video streaming without requiring high power computing systems. This is especially critical when used with multiple source video encoders.

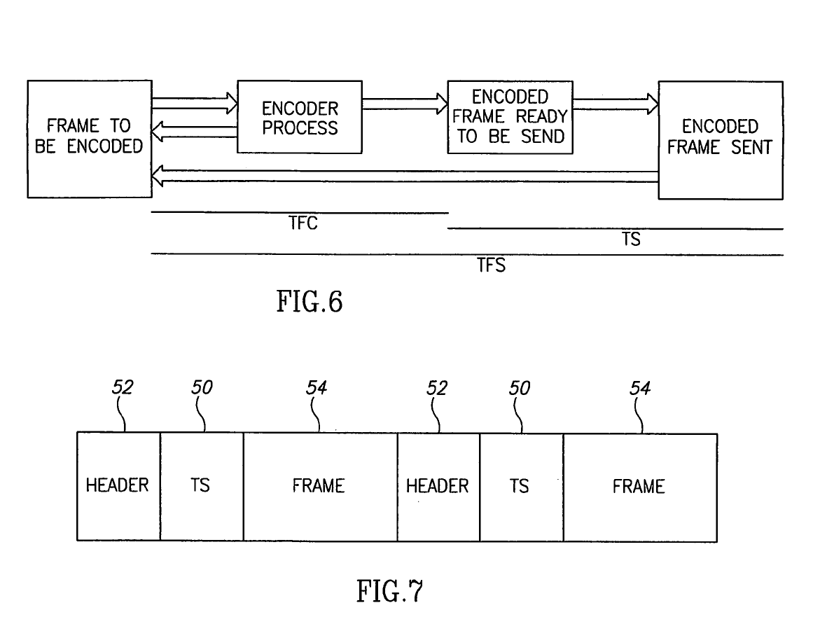

Reference is now made to FIG. 6, which is a schematic bock diagram illustration of the encoding of a video stream on a time scale.

Generally, there are three time parameters associated with encoding video stream:
TIME_FRAME_COMPRESSION (TFC)—The time for compression of a single frame. It may be changed depending on encoder resources.
TIME_FRAME_TO_SEND (TFS)—The average time to send each frame, defined by the environment. On a 10 frames per second case (10 fps), TFS=1 s/10=100 ms.
TIME_SLEEP (TS)—The time the encoder “waits” before sending the frame. It is defined as: TS=TFS−TFC.

As described hereinabove with reference to FIGS. 1 and 2, each frame 17 is encoded by the encoder 16 (time=TFC). The encoded frame is then “held” frame rate controller determines the “waiting” time

Reference is now made to FIG. 7, which is a schematic illustration of a video streaming format, constructed and operative according to an embodiment of the invention.

The video streaming format comprises the addition of the wait time (TS) 50 to the header 52 before each frame 54.

By adding TS at the beginning of each frame, the total overhead on an IP packet would be less then 2%, which is not critical.

Thus, the decoder 34 at the client site 14 can decide whether to “freeze” (hold a frame) or “accelerate” (decrease the viewing time) irrespective of the bandwidth.

Since, the client is responsible for buffering the data received and since the buffer has dynamical size, the client can obtain a higher quality of video stream.

In an alternative embodiment, the client can communicate with the rate frame controller 40 coupled to the encoder 16 at the source 10 to recommend the speed at which the encoded frames should be sent.

The above examples and description have of course been provided only for the purpose of illustration, and are not intended to limit the invention in any way. It will be appreciated that numerous modifications, all of which fall within the scope of the present invention, exist. Rather the scope of the invention is defined by the claims that follow:

We claim:

1. A method for generating low delay video streaming, the method including the steps of:
inputting the bit rate desired for outputting the received video stream into a buffer;
determining the size of said buffer according to said bit rate;
adjusting said bit rate; and
repeating the steps of determining and adjusting thereby to output the video stream at the highest bit rate consistent with optimum levels of quality for a pre-determined period of delay.

2. A method according to claim 1, wherein said step of determining comprises the step of:
defining the “Current_Pointer” position;
wherein “Buffer Pointer”−“Delta_Buffer_Pointer”<“Current_Pointer”<“Buffer Pointer”+“Delta_Buffer_Pointer”.

3. A method according to claim 1, wherein said step of varying comprises the steps of:
determining whether the “Current_Pointer” is within the range appropriate to the current bit rate; and
if the “Current_Pointer” is within said range, recording a plurality of measurements of the time taken for a message from the server's transmitter to the client's receiver and back again to the transmitter (RTT); and
if the “Current_Pointer” is within said range, increasing the bit rate.

4. A method according to claim 3, wherein said step of varying further comprises the steps of:
if the “Current_Pointer” is lower than the increased current bit rate range, reducing the bit rate.

5. A method according to claim 1, wherein said step of varying comprises the steps of:
determining whether the “Current_Pointer” is within the range appropriate to the current bit rate; and
if the “Current_Pointer” is lower than said range, reducing the bit rate.

6. A method according to claim 1, further comprising the steps of:
assigning a header to a first frame of a series of frames of a video stream to be encoded;
allocating a period of time to said first frame before encoding, said period of time corresponding to the delay time of said first frame;
compressing said first frame; and
repeating said steps of assigning, allocating and compressing for each subsequent frame to be encoded.

7. A method according to claim 6, further comprising the steps of:
transmitting said encoded series of frames to a buffer located at the client site;
adjusting the size of said buffer in response to a dynamically varying bandwidth.

8. A method for smoothly displaying the frames of a video stream, the method including the steps of:
assigning a header to a first frame of a series of frames of a video stream to be encoded;
allocating a period of time to said first frame before encoding, said period of time corresponding to the delay time of said first frame;
compressing said first frame; and
repeating said steps of assigning, allocating and compressing for each subsequent frame to be encoded.

9. A method according to claim 8, further comprising the steps of:
transmitting said encoded series of frames to a buffer located at the client site; and
adjusting the size of said buffer in response to a dynamically varying bandwidth.

10. A method according to claim 9, wherein said step of adjusting comprises the steps of:
inputting the bit rate desired for outputting the received video stream into a buffer;
determining the size of said buffer according to said bit rate;
adjusting said bit rate; and
repeating the steps of determining and adjusting thereby to output the video stream at the highest bit rate consistent with optimum levels of quality for a predetermined period of delay.
